(19) United States
(12) Patent Application Publication
(10) Pub. No.: US 2018/0259666 A1
(43) Pub. Date: Sep. 13, 2018

(54) MARINE MIXED-SPREAD SYSTEM AND METHOD FOR DATA ACQUISITION

(71) Applicant: CGG SERVICES SAS, Massy Cedex (FR)

(72) Inventors: Risto SILIQI, Paris (FR); Thomas BIANCHI, Paris (FR); Raphael STERNFELS, Antony (FR); Jean-Marie LAPASSET, Singapore (SG); Francois LE GOFF, Nantes (FR)

(21) Appl. No.: 15/455,381

(22) Filed: Mar. 10, 2017

(51) Int. Cl. G01V 1/38

(52) U.S. Cl. CPC G01V 1/3808

(57) ABSTRACT

Method and marine mixed-spread seismic acquisition system that includes a single first streamer towed by a first vessel in water; a source towed by the first vessel and configured to generate seismic waves; and plural autonomous underwater vehicles (AUVs) configured to record reflected seismic waves. The single first streamer includes plural seismic receivers configured to also record the reflected seismic waves.

### BACKGROUND

### Technical Field

Embodiments of the subject matter disclosed herein generally relate to methods and systems and, more particularly, to mechanisms and techniques for acquiring seismic data in a marine environment with a mixed-spread system of receivers.

### Discussion of the Background

Marine seismic data acquisition and processing generate a profile (image) of a geophysical structure under the seafloor. This image is generated based on recorded seismic data. The recorded seismic data includes pressure and/or particle motion related data associated with the propagation of a seismic wave through the earth. While this profile does not provide an accurate location of oil and gas reservoirs, it suggests, to those trained in the field, the presence or absence of these reservoirs. Thus, providing a high-resolution image of geophysical structures under the seafloor is an ongoing process. The image illustrates various layers that form the surveyed subsurface of the earth.

Reflection seismology is a method of geophysical exploration to determine the properties of earth's subsurface, which is especially helpful in determining the above-noted reservoirs. Marine reflection seismology is based on using a controlled source of energy that sends the energy (seismic waves) into the earth. By measuring the time it takes for the reflections and/or refractions to come back to plural receivers, it is possible to evaluate the depth of features causing such reflections. These features may be associated with subterranean hydrocarbon deposits.

A traditional system for generating seismic waves and recording their reflections off the geological structures present in the subsurface includes a vessel that tows an array of seismic receivers provided on streamers. The streamers may be disposed horizontally, i.e., lying at a constant depth relative to the ocean surface. The streamers may have other than horizontal spatial arrangements. The vessel also tows a seismic source array configured to generate a seismic wave. The seismic wave propagates downward and penetrates the seafloor until eventually a reflecting structure (reflector) reflects the seismic wave. The reflected seismic wave propagates upward until detected by the receiver(s) on the streamer(s). Based on the data collected by the receiver(s), an image of the subsurface is generated.

However, this traditional configuration is expensive because the cost of streamers is high. Further, due to the great length of the streamers, e.g., 10 km, the streamer array is difficult to maneuver around various obstacles, e.g., an oil platform.

New technologies deploy plural seismic sensors on the bottom of the ocean (ocean bottom stations) to avoid this problem. Even so, positioning the seismic sensors remains a challenge. Such technologies use permanent receivers set on the ocean bottom, as disclosed in U.S. Pat. No. 6,932,185, the entire content of which is incorporated herein by reference. In this case, the seismic sensors are attached to a heavy pedestal. A station that includes the sensors is launched from a vessel and arrives, due to its gravity, at a desired position and remains on the bottom of the ocean permanently. Data recorded by sensors is transferred through a cable to a mobile station. When necessary, the mobile station may be brought to the surface for data retrieval.

Although the ocean bottom nodes better handle the various obstacles present in the water, using them is still expensive and difficult because the sensors and corresponding pedestals are left on the seafloor. Further, positioning the ocean bottom nodes is not straightforward.

An improved approach to these problems is the use of plural (e.g., thousands) autonomous underwater vehicles (AUVs) for carrying the seismic sensors and collecting the seismic data. The AUVs may be launched from a deployment vessel, guided to a final destination in the ocean, instructed to record the seismic data, and then instructed to surface for retrieval. Such a system is disclosed in U.S. Pat. No. 9,417,351, which is assigned to the assignee of the present application. However, many challenges remain with the use of a large number of AUVs for collecting seismic data. One such challenge is the correct positioning of the AUVs because measuring and/or predicting the positions of underwater AUVs is still challenging.

Accordingly, it would be desirable to have systems and methods that refine/improve the positions of underwater receivers participating in a seismic survey.

### SUMMARY

According to one exemplary embodiment, there is a marine mixed-spread seismic acquisition system that includes a single first streamer towed by a first vessel in water; a source towed by the first vessel and configured to generate seismic waves; and plural autonomous underwater vehicles configured to record reflected seismic waves. The single first streamer includes plural seismic receivers configured to also record the reflected seismic waves.

According to another exemplary embodiment, there is a method for collecting seismic data with a marine mixed-spread seismic acquisition system. The method includes a step of towing a single first streamer with a first vessel in water, a step of towing a source with the first vessel, wherein the source is configured to generate seismic waves, and a step of deploying in water plural autonomous underwater vehicles configured to record reflected seismic waves. The single first streamer includes plural seismic receivers configured to also record the reflected seismic waves.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-1D are schematic diagrams of various mixed-spread system that includes at least one streamer and plural AUVs;

FIG. 2 is a schematic diagram of a mixed-spread system that includes two single streamers sandwiching plural AUVs;

FIG. 3 illustrates the configurations of a traditional streamer based seismic survey system and a mixed-spread survey system;

FIG. 4 illustrates another mixed-spread system having various zones of AUVs;

FIG. 5A illustrates a mechanism for collecting and deploying the AUVs of a mixed-spread system while the streamers advances along a traveling path;

FIG. 5B illustrates the deployment and recovery capacities for using AUVS with a mixed-spread system;

FIG. 6 illustrates a mixed-spread system in which the AUVs move from one slice of the survey to another one with their own propulsion systems;

FIG. 7 illustrates the turning of a vessel that tows a streamer in concert with the moving of the AUVs;

FIG. 8 is a flowchart of a method for moving the AUVs from one slice of the survey to the next slice;

FIG. 9 illustrates a mixed-spread system in which the AUVs are located both in front and behind the source, along the inline;

FIG. 10 illustrates a mixed-spread system in which lines of AUVs are interleaved both in the inline and cross-line;

FIG. 11 illustrates the increased line density achieved by using a mixed-spread system;

FIG. 12 illustrates a mixed-spread system having perturbation regions close to the sources;

FIG. 13 illustrates a mixed-spread system having regions of tolerance for the AUVs;

FIG. 14 illustrates a mixed-spread system in which the vessels are staggered both on the inline and cross-line;

FIG. 15 illustrates a mixed-spread system in which the AUVs extend past the streamers along the cross-line;

FIG. 16 is a flowchart of a method for designing a seismic survey that uses a mixed-spread system;

FIG. 17 is a flowchart of a method for collecting seismic data with a mixed-spread system;

FIG. 18 is a schematic illustration of an AUV; and

FIG. 19 is a schematic diagram of a computing device that performs one or more of the methods noted above.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a mixed-spread acquisition system that has two streamers and plural AUVs located between the streamers. However, the embodiments to be discussed next are not limited to two streamers and plural AUVs, but may be applied to other combinations of streamers and AUVs, for example, one streamer and one line of AUVs.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys use more and more AUVs (i.e., vehicles that are not connected with wires to a vessel or a controller) for collecting the seismic data associated with the surveyed underground. According to an embodiment, a novel seismic acquisition system includes a single streamer towed by a vessel in water, a source towed by the same vessel and configured to generate seismic waves, and plural AUVs configured to record reflected seismic waves. The single streamer includes plural seismic receivers configured to also record the reflected seismic waves.

If this seismic acquisition is used to collect the seismic data, a total illumination of the surveyed subsurface is increased. In this respect, a traditional approach for efficient marine acquisition uses wide-tow streamers, e.g., a spread of receivers. Increasing the width of the spread of receivers allows the increase of the width of the illumination imprint generated by the actuation of one seismic source. However, with the traditional approach is not possible to increase the width of the spread (i.e., adding more streamers) beyond a certain number because the streamer vessel has a limited power capability of towing the streamers. The present system does not have this limitation as many of the traditional streamers are substituted by AUVs. The activation of a second seismic source, distant from the first seismic source, e.g., as far as the width of the receiver-spread, would duplicate the total illumination imprint of this novel acquisition system. The flexibility of deployment of a mixed-spread system (streamers and AUVs) allows to design efficient seismic acquisition systems based on the capacity of deploying separated multiple sources.

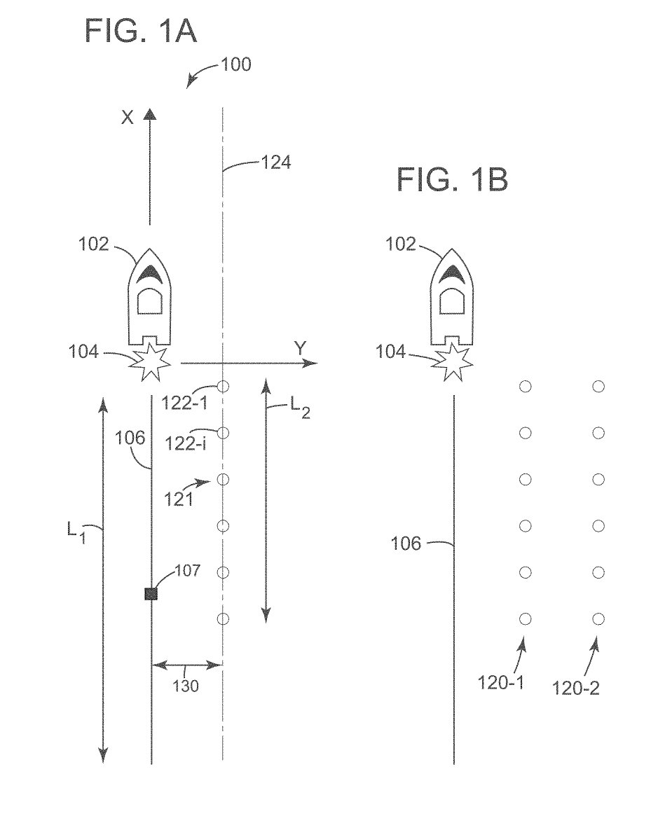

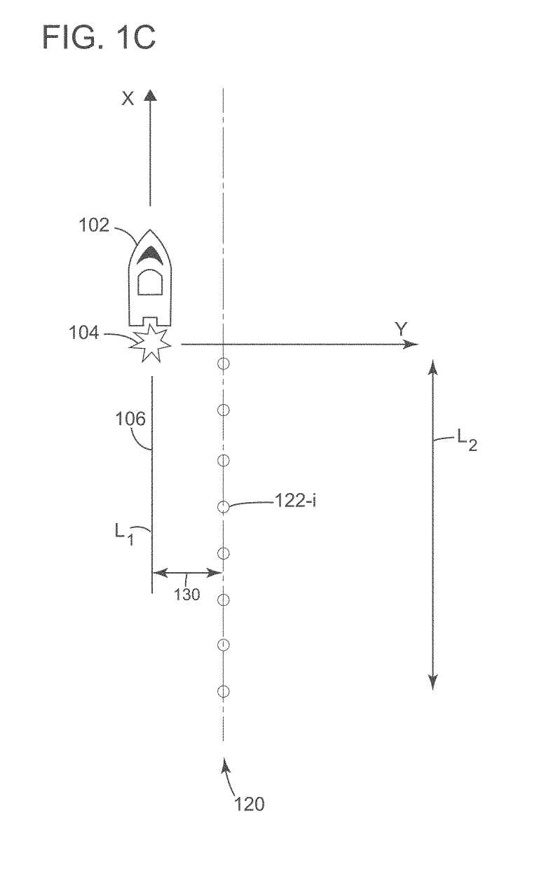

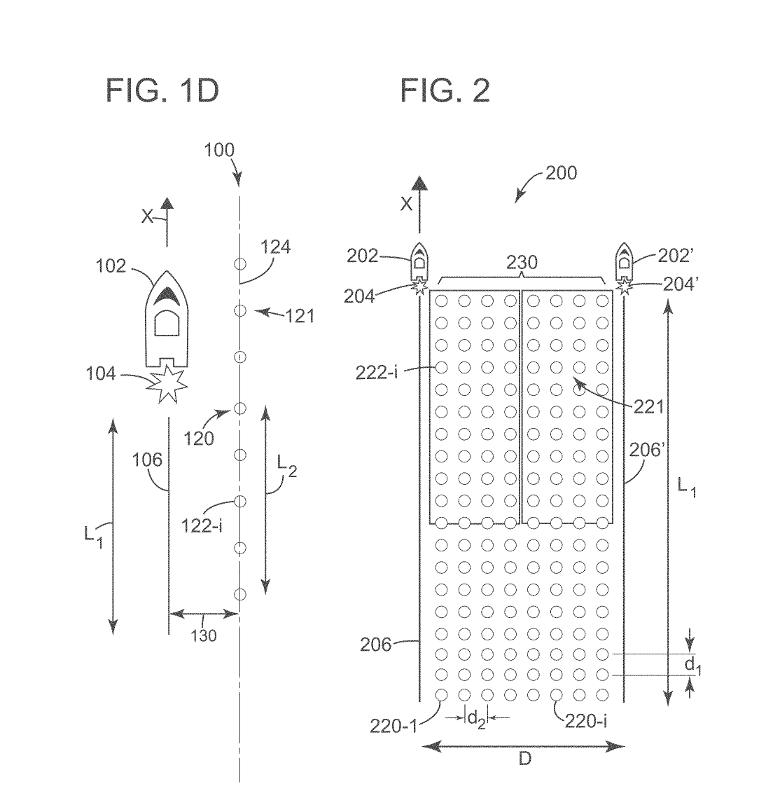

According to an embodiment illustrated in FIG. 1A, a mixed-spread seismic data acquisition system 100 includes a vessel 102 that tows a source 104 and a single streamer 106 and an array 121 of AUVs. The source and single streamer are towed by a same vessel 102. Streamer 106 has a length L1 and extends along an inline direction X, which is also the traveling path of the vessel. Streamer 106 includes plural seismic receivers 107 (only one is shown in the figure for convenience) configured to record the reflected, and/or refracted and/or diffracted seismic waves. The array 121 of AUVs 122-i may extend along a line 124, which is substantially parallel to the inline X. The term “substantially” in this context is related to the strength of the existing marine currents, which makes the AUVs to deviate from their assigned positions along the line 124. As an example, the term “substantially” may include a deviation of about 10% from a value of an intended offset distance 130 between the inline direction X and line 124. AUVs 122-i also include seismic receivers for recording the reflected waves.

The number of AUVs 122-i may vary between 2 and hundreds or thousands. Note that for the embodiment illustrated in FIG. 1A, the first AUV 122-1 in the array 121 is either on or behind a cross-line direction Y that has its origin on the source 104 towed by vessel 102. In other words, the AUVs in the embodiment of FIG. 1A are located behind the source 104, along the inline X, with the possible exception of the first AUV 122-1, which may be at the same inline position as source 104.

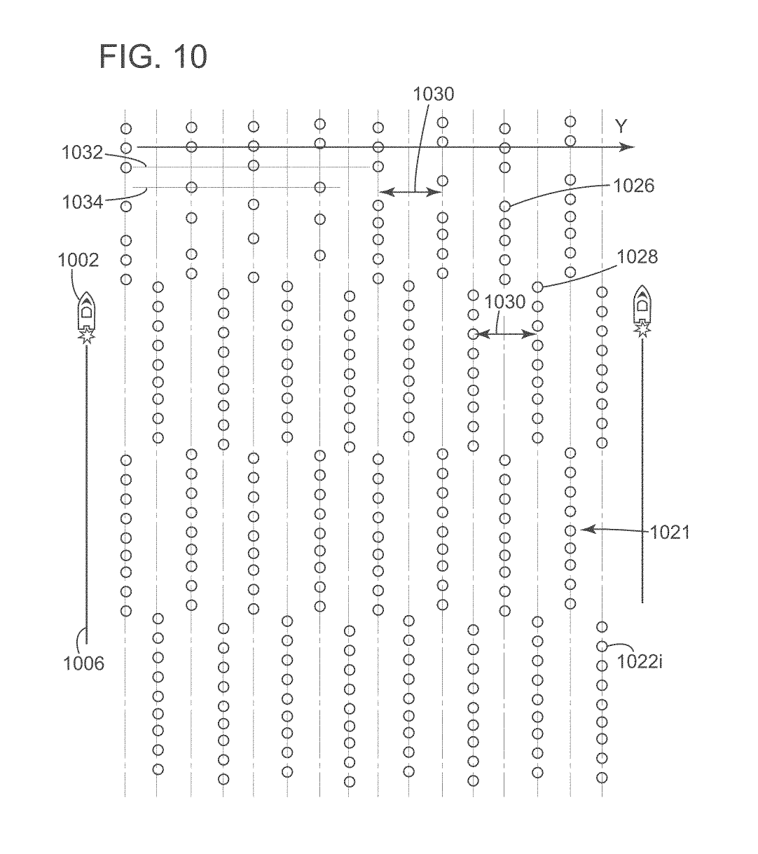

The array 121 of AUVs may include more than one line of AUVs, as illustrated in FIG. 1B, which shows two lines 120-1 and 120-2 of AUVs. Those skilled in the art would understand that plural lines 120-i of AUVs 122i are located substantially parallel to the inline X and may belong to a single array 121. The AUVs are shown in FIG. 1A as extending along a length L2 of line 124, with L2 being smaller than the length L1 of the streamer 106. However, in one application, as illustrated in FIG. 10, the length L2 of line 120 of AUVs is longer than the length L1 of the streamer. In still another application, the AUVs extend along line 124 above source 104, as illustrated in FIG. 1D. This arrangement in which part of the AUVs are distributed ahead of source 104 and part behind source 104 is called a split-spread arrangement. Those skilled in the art would understand that any combination of AUVs as illustrated in FIGS. 1A-1D is possible and intended to be described by this application.

The AUVs may be stored on a mother vessel (to be discussed later) or on vessel 102 before or after recording the data. The mother vessel travels to the location of the seismic survey and launches the AUVs in water. The AUVs move then to the assigned underwater positions that are programmed into their controls. After all the AUVs are in place, they may move underwater, in tandem with vessel 102 and streamer 106, to collect the seismic data. Note that the AUVs shown in the figures may move with the same speed and in the same direction as streamer 106. In one application, the speed of the AUV is slightly (e.g., 10 to 40%) higher or lower than that of the streamer. While the embodiments discussed above has shown a single streamer vessel towing a single streamer, it is possible to have multiple streamer vessels (as discussed next) and/or each vessel towing plural streamers. Further, as discussed later, it is possible that the AUVs are stationary while recording the seismic data and while the streamer is moving.

FIG. 2 shows an embodiment in which two vessels 202 and 202′ are towing corresponding sources 204 and 204′, and corresponding single streamers 206 and 206′. Plural lines 220-i of AUVs (which form array 221) are located along corresponding lines, parallel to the inline X, on which the streamers extend. The plural lines of AUVs may have any of the configurations discussed in FIGS. 1A-1D, or a combination of these configurations. FIG. 2 shows that a distance between the two streamers 206 and 206′ is D and the lengths of the two streamers is the same, L1. Area L1 times D is shown in FIG. 2 being filed with the AUVs. The inline distance d1 between two adjacent AUVs (from the same line) may be in the order of meters, tens of meters or hundreds of meters. The cross-line distance d2 between two adjacent AUVs from different lines may be in the order of meters, tens of meters or hundreds of meters. An illumination imprint of such arrangement is illustrated in FIG. 2 as element 230 and has an area given by D times L₁/2. Any values for distances d1 and d2 are possible.

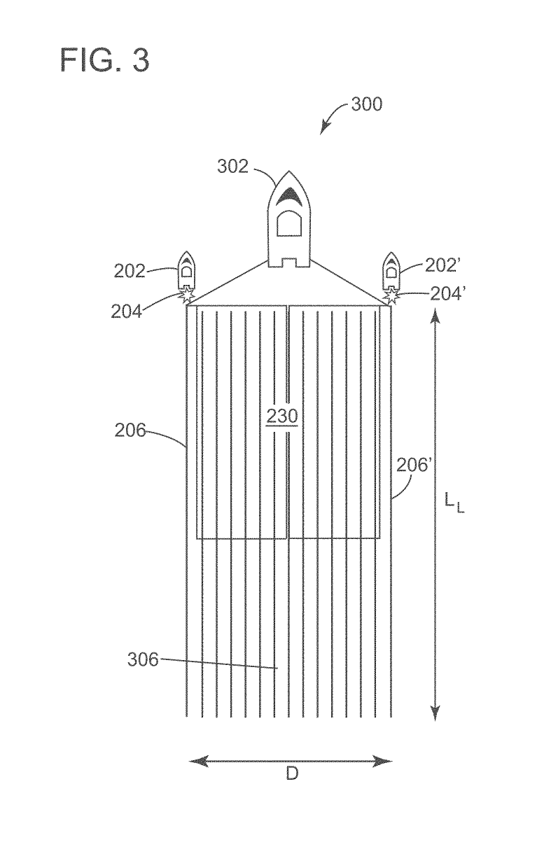

To achieve an equivalent illumination imprint 230 with a traditional acquisition system 300 that includes only plural streamers 306, FIG. 3 shows that a traditional vessel 302 needs to tow many such streamers 306. The width D of the spread would be limited by the wide tow capacity of the seismic vessel 302 and deploying seismic sources at the edge of the spread would be challenging and risky.

The mixed-spread 100 discussed above with regard to FIGS. 1A-2 avoids these problems by replacing the receivers of the inner streamers by AUVs, which relax the tow constrains of a wide spread system, which results in towing only the single streamers.

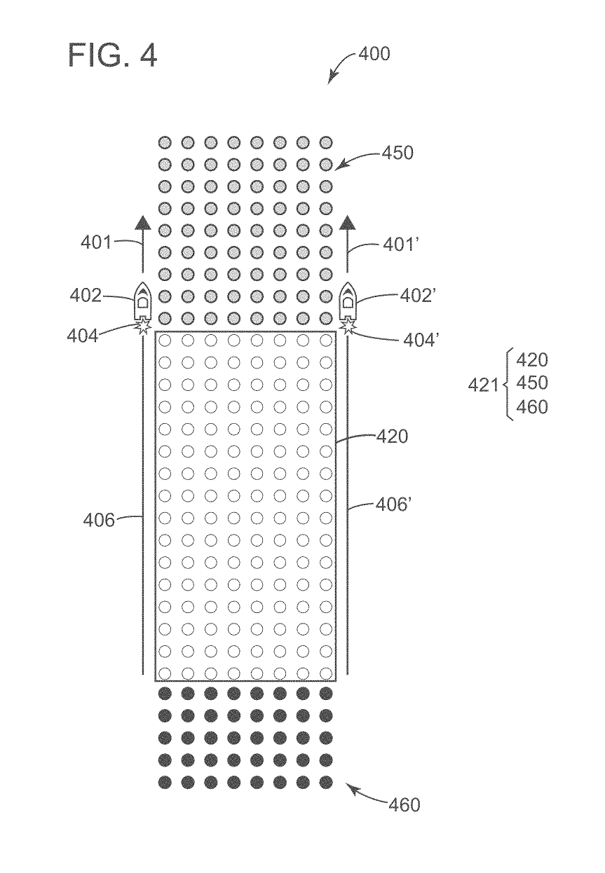

The towed streamers could navigate quite fast, e.g., 9 to 10 km/h, but the navigation capabilities for the AUVs (depending what type of AUVs is used) may be limited, i.e., they may have a traveling speed less than the traveling speed of the streamers. If this is the case, according to an embodiment illustrated in FIG. 4, it is possible to deploy plural collections 420, 450 and 460 of stationary AUVs in between the navigation paths 401 and 401′ of the two seismic vessels 402 and 402′ to make the data acquisition feasible. In other words, a first collection 420 of AUVs is located between streamers 406 and 406′, a second collection 450 has been deployed in advance of vessels 402 and 402′, and a third collection 460 is located behind the streamers 406 and 406′. The plural collections 420, 450 and 460 are considered to form an array 421 of AUVs.

However, in one embodiment, the array 421 is considered to include only the first collection 420 (i.e., the collection including the active AUVs). These AUVs are deployed before the seismic vessels arrive at these locations. The first collection 420 is active, i.e., recording seismic data generated by the sources 404 and 404′, the second collection 450 is idle, waiting for the seismic sources to arrive, and the third collection 460 has already recorded the seismic data and is waiting either to be instructed to move to a new location or to be picked up by the mother vessel. For these reasons, the first collection is also called the active sector of AUVs, the second collection is called the waiting sector of AUVs, and the third collection is called the recorded sector of AUVs. By rotating the three collections 420, 450, and 460 with an appropriate timing and having enough AUVs in each collection, it is possible to provide enough AUVs ahead of the streamer vessels for continuously recording seismic data while the streamer vessels advance along directions 401 and 401′ with a constant speed and the sources continuously shoot.

Note that in one application, the second collection is much larger than the first collection. In another application, the second collection is much larger than the first and third collections. In one embodiment, the size of the second and third collections is changing as the AUVs are collected from the third collection and deployed as part of the second collection. An exemplary size of these collections may be calculated as now discussed. Those skilled in the art would understand that other sizes may be used based on the following observations and calculations.

To feed the second collection a dynamic mobilization/recording/demobilization of the AUVs is necessary. At a high level, this scenario needs to fulfill the following constraints: 1) ensure the prior mobilization of the second collection (also called waiting sector), 2) ensure the activation of the first collection (also called active sector) and 3) ensure the demobilization of the third collection (also called the recorded sector).

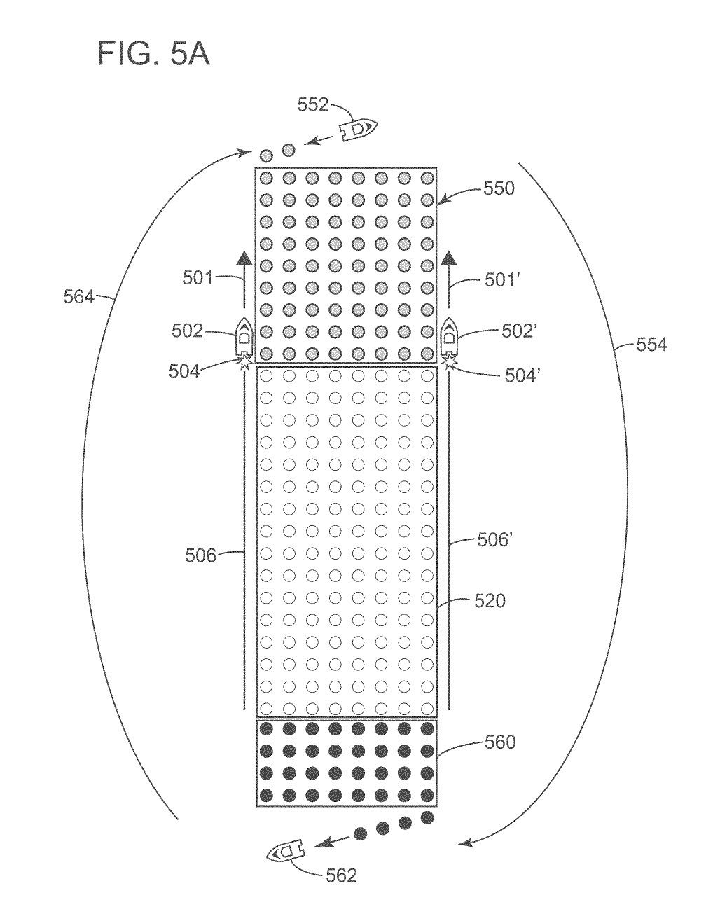

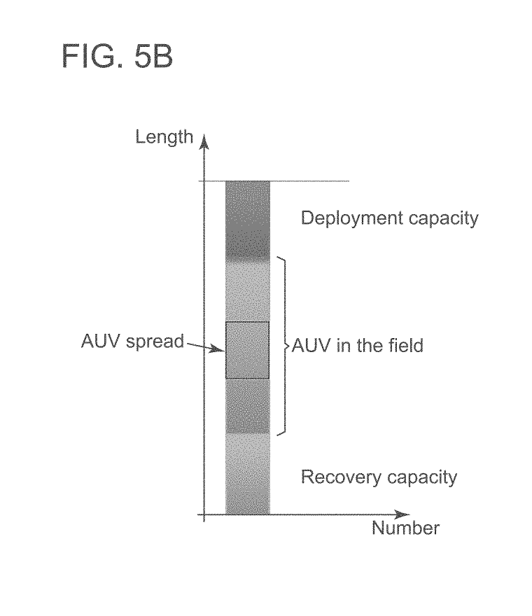

A continuous mobilization/demobilization campaign 500 may continuously deploy AUVs in front of the seismic vessels that tow the single streamers for preserving a security buffer of already deployed AUVs, as illustrated in FIG. 5A. FIG. 5A shows a mother vessel 552 deploying AUVs in front of vessels 502 and 502′, for maintain the size of the waiting sector 550. Note that rows of AUVs of the waiting sector 550 become part of the active sector 520 as vessels 502 and 502′ advance along traveling paths 501 and 501′. At the same time, rows of AUVs of the active sector 520 become part of the recorded sector 560. In this embodiment, the AUVs in these sectors are stationary. However, it is possible that the AUVs in these sectors also travel with a given speed, along directions 501 and 501′. FIG. 5A shows how mother vessel 552 releases in water a number of AUVs that travel, based on their propulsion system to the assigned position that is part of the waiting sector 550, while another mother vessel 562 collects AUVs from the recorded sector 560 that have finalized their recordings. At a certain point, the two mother vessels 552 and 562 would swap their positions, as indicated by arrows 554 and 564 and continue to release and collect the AUVs.

For a given nominal AUV grid (dx, dy) of a collection of AUVs having the area given by LxD, the number of necessary active AUVs is given by:

$${N}_{active} = \frac{L}{dx} \frac{D}{dy} \qquad ( 1 )$$

The total number of AUVs required to maintain a stationary spread is related to the:
size of the sector D×L,
length of the line X;
acquisition speed Vₛ;
mobilization (deployment) speed m; and
demobilization (recovery) speed d.

For a given time interval Δt, the number Nₙₑₓₜ of required extra active AUV is given by:

$${N}_{next} = \frac{{V}_{s} Δ t}{dx} \frac{D}{dy} = {V}_{s} Δ t \frac{{N}_{active}}{L} . \qquad ( 2 )$$

The same amount of AUVs Nₚₐₛₜ is left behind by the seismic survey, i.e.;

Nₚₐₛₜ=Nₙₑₓₜ. (3)

During the same lapse of time, the numbers of deployed and recovered AUVs are given by:

N_{mob}=mΔt (4)

N_{demob}=dΔt. (5)

The balance of AUVs on the field is given by:

Nₜₒₜₐₗ=N_{active}+(Nₙₑₓₜ−N_{mob})+(Nₚₐₛₜ−N_{demob}). (6)

The ideal situation would be to have the speeds of mobilization/demobilization equal to completely balance the number of AUVs in the waiting sector Nₙₑₓₜ and in the recorded sector Nₚₐₛₜ, as given by equation (6), i.e.,

$$m = d = \frac{{N}_{active}}{L \text{/} {V}_{s}} , \qquad ( 7 )$$

where L/Vₛ corresponds to the time to navigate the length of the spread (e.g., about an 1 h for a 8 km spread). Thus, the ideal situation would be to deploy and recover the full AUV array in one hour, which is challenging. In practice, an initial deployment of a larger AUV array may be necessary, as illustrated in FIG. 5A.

To navigate a full array of length X, the necessary time interval is:

$$T = \frac{X}{{V}_{s}} . \qquad ( 8 )$$

After the mobilization/demobilization operation during the lapse of time considered above, the number N_{field} of remaining AUVs in the field is given by:

$${N}_{field} = {N}_{active} \frac{X}{L} - ( m + d ) \frac{X}{{V}_{s}} . \qquad ( 9 )$$

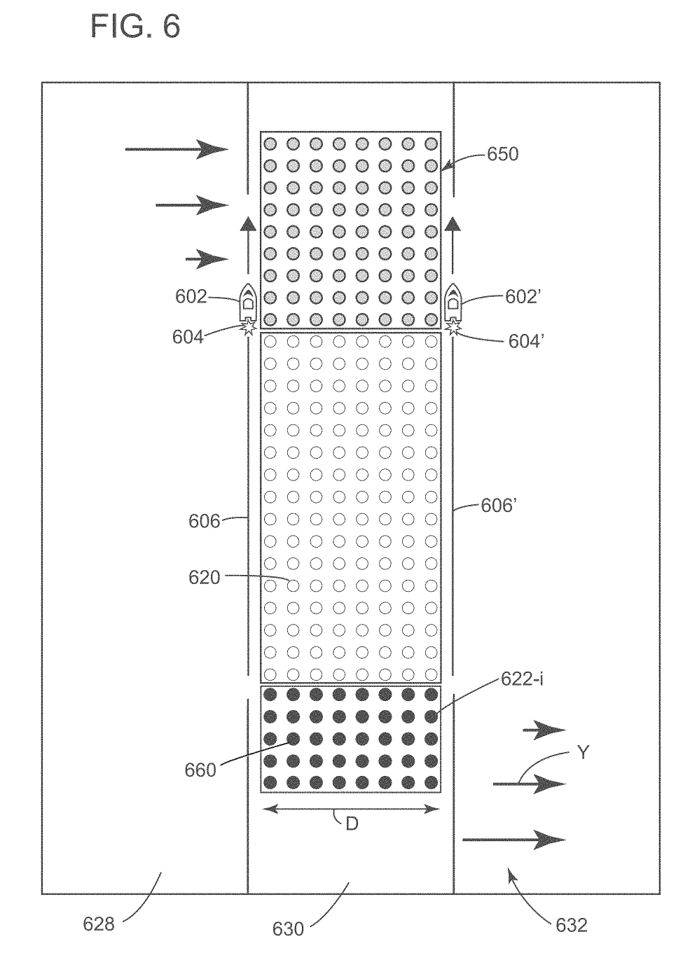

While the above formulae may be used to optimize the deployment and retrieval of the AUVs with two mother vessels for the embodiment discussed with regard to FIG. 5A, in another embodiment it is possible to reuse the AUVs without continuously deploying and retrieving them, as now discussed with regard to FIG. 6.

For this embodiment, assume that the AUVs have been deployed for an entire survey swath, i.e., along an entire slice 630 of the seismic survey area. It is know that a given survey area is divided into small slices and the seismic survey system “sweeps” each slice at least once. FIG. 6 shows the AUVs array being divided into three sections, the active section 620, the waiting section 650, and the recorded section 660.

According to this embodiment, the AUVs in the active section 620 are instructed/programmed to remain stationary and record the seismic data with the streamers are passing them. The AUVs in the recorded section 660, having finished recording the data, are instructed/programmed to start their propulsion system and advance along the cross-line Y to move to the next slice 632 to be surveyed. The AUVs from the waiting section 650, have been previously instructed to move from a previous slice 628 to the current slice 630 and thus, these AUVs are now ready to record seismic data.

Thus, each AUV 622-i has to travel a distance equal to the width of the slice or spread D. If the speed of the AUVs is Vₐ, the necessary time interval for traveling from one slice to the next slice is given by:

$$Δ {t}_{a} = \frac{D}{{V}_{a}} . \qquad ( 10 )$$

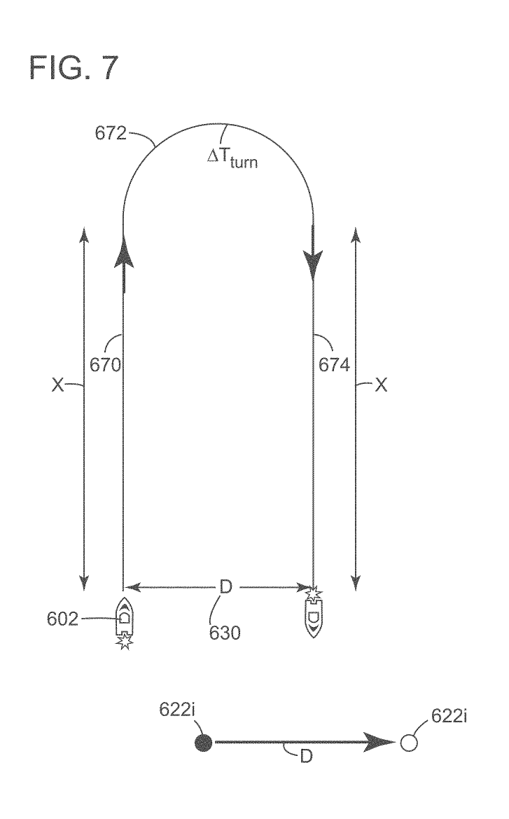

This time interval should be larger than the time required for the seismic vessels 602 and 602′ to finish surveying the slice/swath (i.e., moving along travel path 670) plus the time to turn to the next slice/swath (i.e., moving along travel path 672) and to reach the same latitude again (i.e., moving along travel path 674), as illustrated in FIG. 7, which time is given by:

$$Δ {t}_{a} < Δ {t}_{s} = \frac{2 x}{{V}_{s}} + Δ {T}_{turn} . \qquad ( 11 )$$

Combining equations (10) and (11), the size of the run-in AUV buffer in the next swarm could be estimated. This AUV buffer has to be deployed before the run-in and it has a size x given by:

$$x > \frac{{V}_{s}}{2} ( \frac{D}{{V}_{a}} - Δ {T}_{turn} ) . \qquad ( 12 )$$

However, if the speed of the AUV propeller is sufficient to move the AUV over distance D, from one swath to the next, during the turning time ΔTₜᵤᵣₙ of the vessel, then, in one embodiment, there is no need for pre-deployment as:

$${V}_{a} > \frac{D}{Δ {T}_{turn}} . \qquad ( 13 )$$

A speed of 1 km/h is sufficient for an AUV to be displaced about 2 km during the 2 h vessel turn for a 2D seismic survey. Note that in the industry, when a seismic vessel tows a single streamer, the survey is called a 2D seismic survey and when a same vessel tows plural streamers, the survey is called a 3D seismic survey.

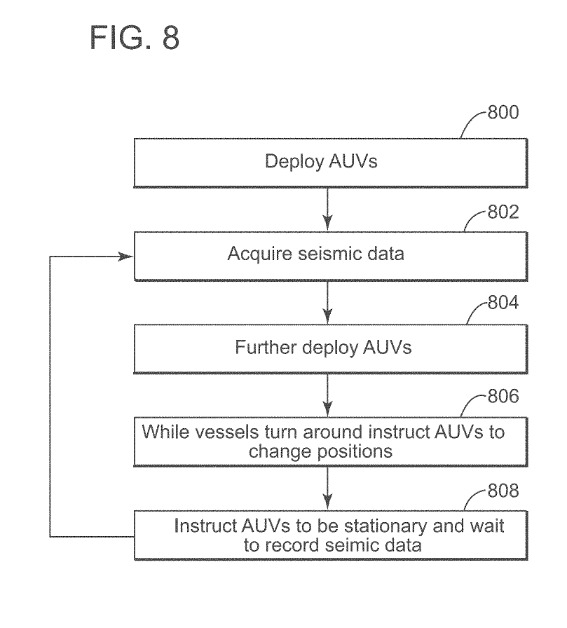

According to another embodiment, it is possible to combine the scenario illustrated in FIG. 5A (i.e., mother vessels deploying and retrieving AUVs) with the scenario illustrated in FIGS. 6 and 7 (i.e., AUVs that slide from one survey slice to another one while the seismic vessel(s) turn) to obtain the following method, which is illustrated in FIG. 8.

According to this method, in step 800 plural AUVs are deployed in the water such that an entire swath is covered with N_{field} AUVs (as calculated in equation (9)) and these AUVs are instructed to be stationary and wait for the seismic vessels. In step 802, seismic data is acquired with a mixed spread of AUVs and one or more streamers using, for example, two 2D seismic vessels advancing along both sides of the array as described in FIG. 4.

In step 804, the number of deployed AUVs is increased by deploying extra AUVs in front of the active sector of AUVs and the AUVs behind the active sector are retrieved as illustrated in FIG. 5A. In step 806, when the seismic vessels reach the end of the slice and start the turn to position for the next slice, as illustrated in FIG. 7, the already deployed AUVs in the field start moving perpendicularly to the vessel's travel direction (i.e., along the cross-line), to move along a distance D to a position in the next slice, as illustrated in FIGS. 6 and 7, with a speed at least as large as the one calculated with equation (13).

When all N_{field} AUVs are redeployed to the next slice, they remain stationary in step 808, ready for the acquisition of the next slice. This process can then be repeated for other slices.

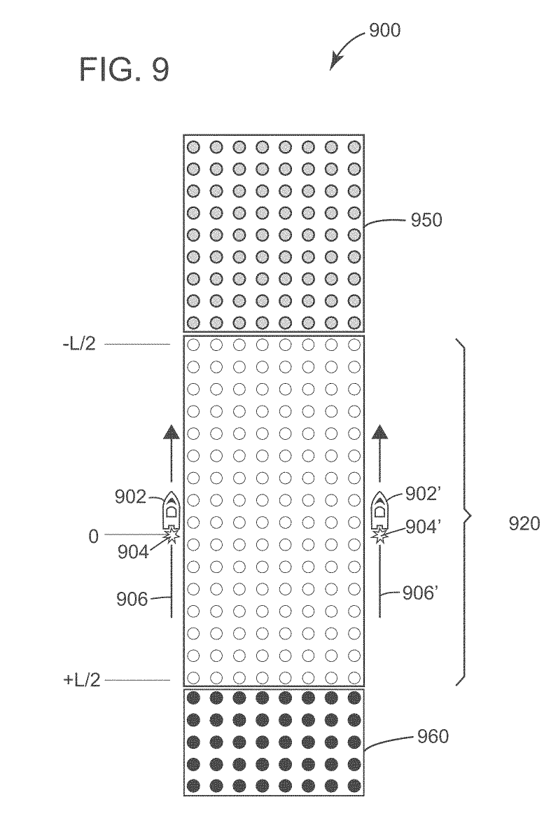

The mixed-spread configuration discussed above may be further modified to improve the efficiency of the seismic data acquisition. For example, in one embodiment as illustrated in FIG. 9, the AUVs of the active region 920 are distributed to be both in front of the sources 904 and 904′, along the inline direction X, and behind them. In other words, the length L of the lines of AUVs is half in front of the sources and half behind the sources. This is a split-spread configuration. This means that the receivers from the AUVs record positive and negative offsets regarding the sources, as illustrated in FIG. 9. This embodiment may also have a recorded sector 960 and a waiting sector 950. The lengths of the streamers towed by the shooting vessels may be shorter than the length L of the active region 920, as shown in the figure. For this configuration, the main function of the receivers located on the streamers is to collect the nearest offset data.

According to another embodiment, the split-spread configuration allows a distribution of positive and negative offsets. Considering the reciprocity of source and receiver regarding the wave travel paths, the data acquired through positive or negative offsets carry the same seismic information. Their joint presence would only improve the signal-to-noise ratio. In order to take advantage of the equivalence between positive and negative offsets, the stationary spread of AUVs could be designed as a patchwork of regions (or lines) with alternate interleaved columns 1026 and 1020 of AUVs as illustrated in FIG. 10. This figure also shows the entire array 1021 of AUVs 1022-i, vessel 1002 and streamer 1006. The various columns 1026 and 1028 of AUVs are separated by the same distance 1030 in a given row, but the cross-line positions of the columns along the cross-line direction Y are different. This approach reduces the required number of AUVs necessary to collect the seismic data. In one application, the rows of AUVs 1032 and 1034 are also interleaved as illustrated in FIG. 10.

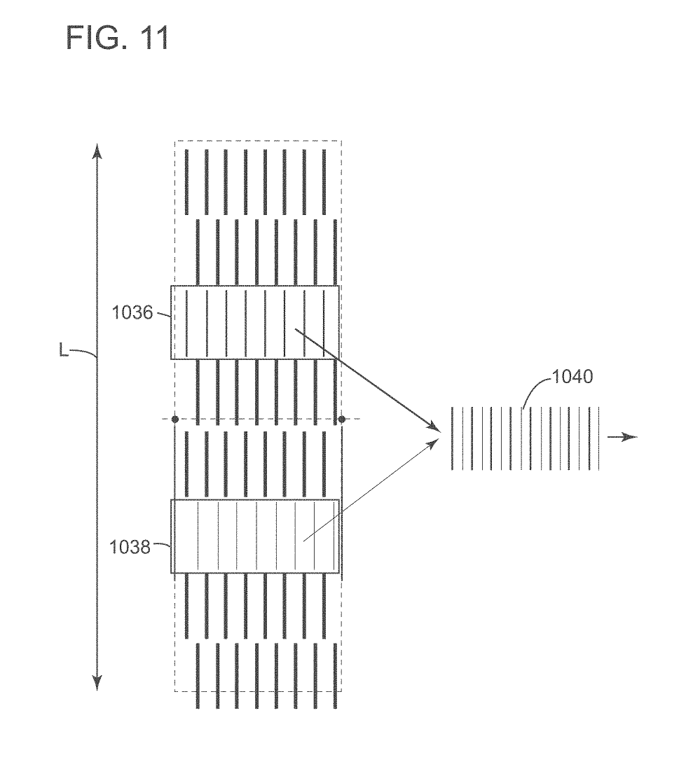

In order to secure a desired cross-line density 1040 of combined positive and negative seismic data, the size of patches 1036 (negative offsets) and 1038 (positive offsets) has to be at most a quarter of the split-spread length L as illustrated in FIG. 11. In fact, the sliding split-spread configuration should encompass in between complementary AUV patches in front and behind as shown in FIG. 11. In another embodiment, a sparser AUV deployment along the inline direction could be achieved thanks to the interleave row aspect illustrated in FIG. 10.

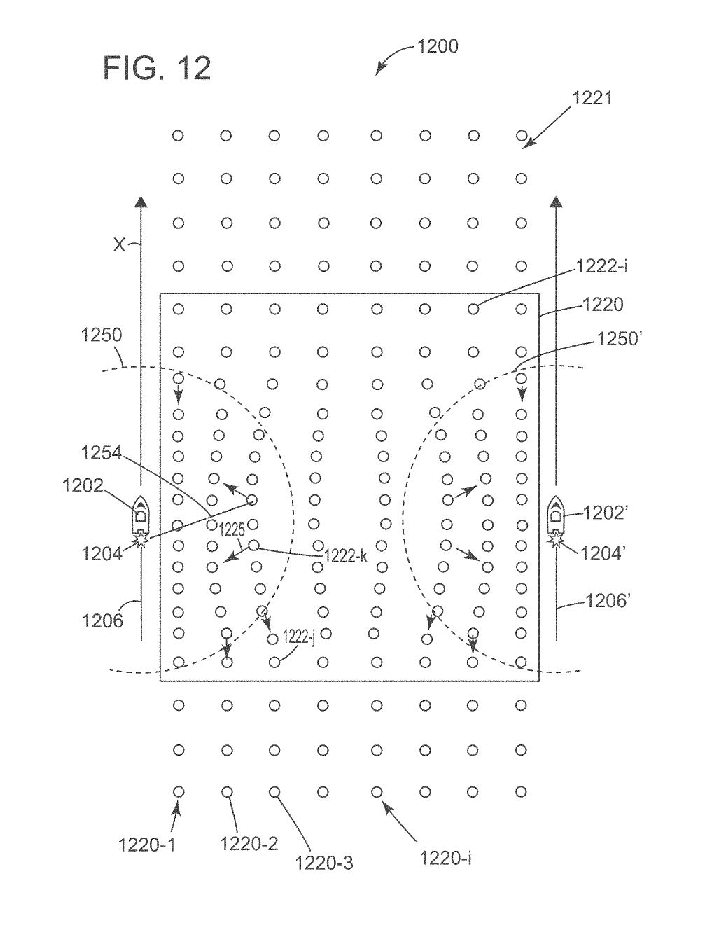

In another embodiment, selected AUVs of the array of AUVs are instructed to change their positions as the seismic vessels that tow the streamers are approaching. In other words, there is a method that dynamically selects and positions AUVs of the array to optimize a regularization of the seismic data. For example, as illustrated in FIG. 12, such a system 1200 includes a first vessel 1202 that tows first source 1204 and first streamer 1206, and a second vessel 1202′ that tows second source 1204′ and second streamer 1206′. The system also includes an array 1221 of AUVs 1222-i. Array 1221 includes at least an active section 1220 of AUVs.

A perturbation region 1250 is selected at least around the first source 1204. In one application, it is also possible to select another perturbation region 1250′, around the second source 1204′. The perturbation region can have any shape, e.g., a full or part of a circle, a full or part of an ellipse, a full or part of a polygon, etc. In one embodiment, the shape and/or areas of perturbation regions 1250 and 1250′ are different. FIG. 12 shows the perturbation regions 1250 and 1250′ being half circles centered on sources 1204 and 1204′, respectively.

Within perturbation region 1250, lines 1220-i of AUVs that form active region 1220, are selected and only their AUVs within the perturbation region are perturbed from their aligned positions. More specifically, AUV 1222-j of line 1220-3 is not perturbed while AUV 1222-k, inside perturbation region 1250, is perturbed as indicated by arrow 1255. In other words, for a given perturbation region 1250, when all the AUVs are aligned along their corresponding lines 1222-i, a spatial density SD of the AUVs is achieved (selected by the system's operator prior to the survey) and this SD is constant as the source 1204 moves along its traveling path X (or inline direction) past the AUVs. However, in this embodiment, the SD of AUVs inside the perturbation region (SD_{inside}) is modified, so that SD_{inside} is different than the SD outside the region (SD_{outside}). The SD may be defined as the ratio of the number of AUVs for a given unit of area.

The type of perturbation applied to the AUVs inside the perturbation region may vary, from a linear type of perturbation in which the displacement of the AUV is proportional (or invers proportional) to the distance M (1254) between source 1204 and the AUV, to a perturbation in which the displacement of the AUV is proportional (or invers proportional) with the square of the distance M (1254) between source 1204 and the AUV, to any mathematical formula that links the distance M to the displacement of the AUV.

In one application, as illustrated in FIG. 12, the AUV are perturbed in such a way that they are attracted toward the source when the source is closest to the AUVs along the cross-line, thus, increasing the SD next to the source. The perturbation shown in FIG. 12 may be described as being similar to having a sinusoid wave that propagates along the lines 1220-i of AUVs, with an amplitude that increases as the line is further away from the source 1204. Those skilled in the art would understand that there are many other types of perturbations that can be applied to the AUVs to increase, for example, the number of AUVs closer to the source within the perturbation region.

To achieve this distribution, vessel 1202 or source 1204 may transmit a perturbation acoustic signal that is received by the AUV and the AUV moves closer to the source right at the time that the source passes by the AUV. Once the source has passed the AUV, the AUVs use their propulsion system to move back to their original positions. In one embodiment, the AUVs may be programmed to move closer to the source after a time t1 after they received the source or vessel perturbation acoustic signal, stay at the perturbed position for a given time interval t2 (which may be calculated a priori based on the speed of the vessel to be enough for the source to pass the AUV) and then move back to the original position. This arrangement can be implemented only for the AUVs closer to vessel 1202, or only for the AUVs closer to vessel 1202′, or for all AUVs.

The SD may vary as the survey progresses (for example, based on the surveyed target depth) and it may be calculated based on the requirement of regularization of the seismic data. One possible goal is to better constrain the data model at near offsets.

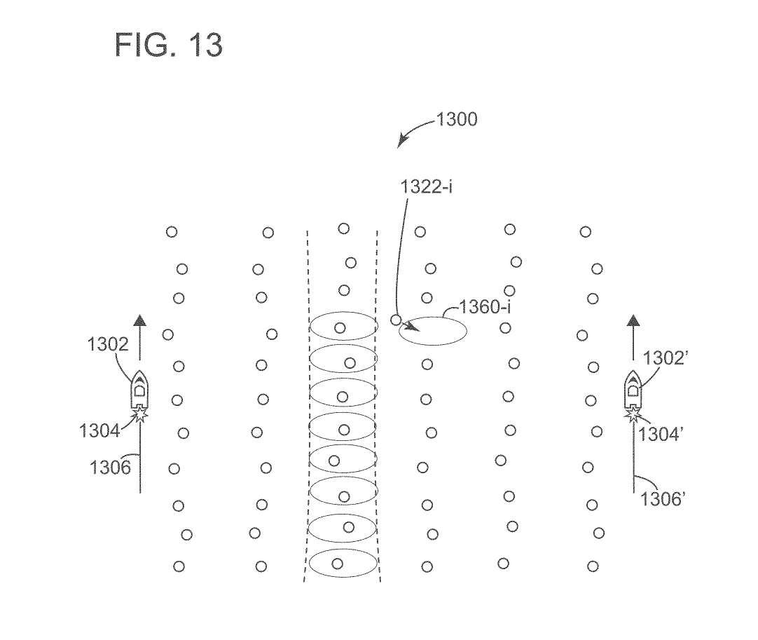

The regularity of the AUV grid could be perturbed by various environmental factors. In some embodiments, instead of fighting to preserve the regularity by the use of AUVs' propellers, which might reduce the battery life and/or cause noise on the recorded seismic, it is proposed to recover the regularity after the acquisition, through regularization (e.g., interpolation) of the seismic data. According to regularization capabilities, regions of tolerance 1360-i (e.g., ellipses or other shapes for which the cross-line size is larger than the inline size) are added to control the lateral displacement need for AUVs, as illustrated in FIG. 13. The command and control system of the AUV array evaluates the location of each AUV and if an AUV 1322-i is located outside its corresponding region of tolerance 1360-i, as also shown in FIG. 13, that AUV is instructed to move back inside region. The size of the region may be calculated prior to the survey, based on the target of the survey.

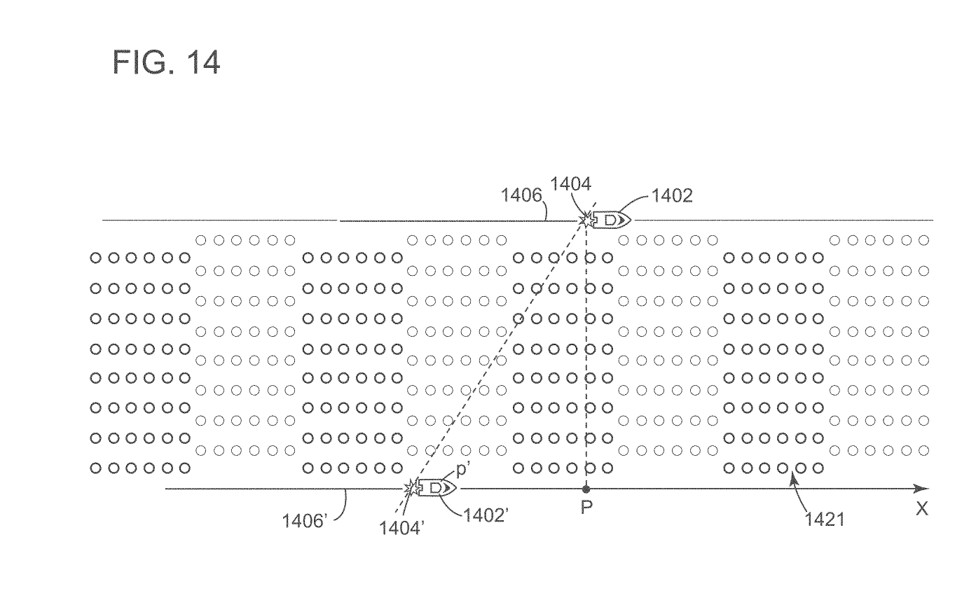

In another embodiment illustrated in FIG. 14, the first and second vessels 1402 and 1402′ are staggered (offset) along the traveling direction X, meaning that an inline position P of the first vessel 1402 along the inline X is different (ahead in the figure) than the inline position P′ of the second vessel 1402′. This means that the sources 1404 and 1404′ are staggered and the streamers 1406 and 1406′ are also staggered. The array 1421 of AUVs may be aligned along lines as in the embodiment of FIG. 9 or interleaved as in the embodiment of FIG. 10. One or more perturbation regions may be applied to this arrangement. The offset along the inline may be calculated to achieve a specific offset/azimuth distribution. The offset along the inline of the seismic vessels is not limited to the combination with split-spread or interleaved arrays of AUVs as illustrated in FIG. 14, but may be applied to any of the previously discussed embodiments.

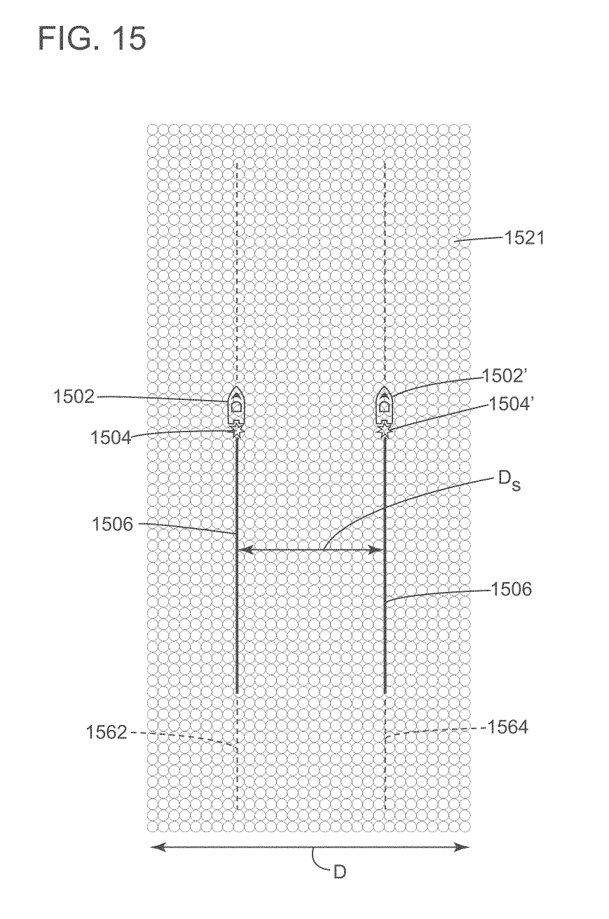

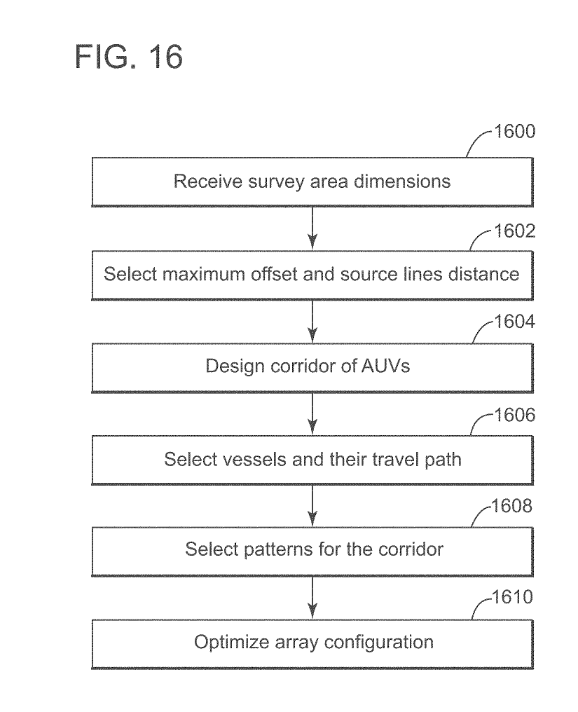

In one embodiment, as illustrated in FIG. 15, the width D of the mixed-spread system may be larger than a distance Dₛ between the source lines 1562 and 1564. In this specific case, the seismic vessels 1502 and 1502′, sources 1504 and 1504′, and streamers 1506 and 1506′ navigate over the array of AUVs.

Any of the mixed-spread systems discussed above or other similar configurations may be planned as following. At a ground facility, for example, a physical location of the operator, the survey's operator receives in step 1600 the survey area's dimensions. The survey operator selects, in step 1602, (1) a maximum required offset between the source and the AUVs and (2) the accepted distance Dₛ between the source lines. In step 1604, based on the information from steps 1600 and 1602, a wide split-spread of AUVs is designed to include a corridor of width D populated with stationary AVUs (i.e., their positions are calculated). In step 1606, two seismic vessels are selected and their travel paths are designed to sandwich the array of AUVs, on both sides of the corridor. The vessels may be selected to be staggered or not. Both seismic vessels could tow a single marine streamer with a pre-determined length, a light 3D streamer spread (i.e., a couple of streamers) or no streamers.

In step 1608, the corridor of AUVs is designed to have one or more patterns. For example, the AUVs may be chosen to follow the grid shown in FIG. 9 or the alternate patterned columns shown in FIG. 10. Even and odd swarms of AUVs have the interleaved pattern of AUVs columns as showed in the FIG. 10. If both patterns are superimposed, the number of columns is duplicated. The size of each swarm is calculated to be at most the quarter of the length L of the selected split-spread.

In step 1610, data regularization considerations are taken into account to optimize the AUVs array configuration. For example, it is possible to fit regions of tolerances around the regular location of AUVs, as illustrated in FIG. 13, to allow triggering the propulsion of AUVs when they step outside these regions.

In order to optimize the near-offset distribution, the AUVs could have the mission to move toward the seismic sources, when the AUVs are close to the sources, and then to go back to their initial location when the sources are far away, as illustrated in FIG. 12.

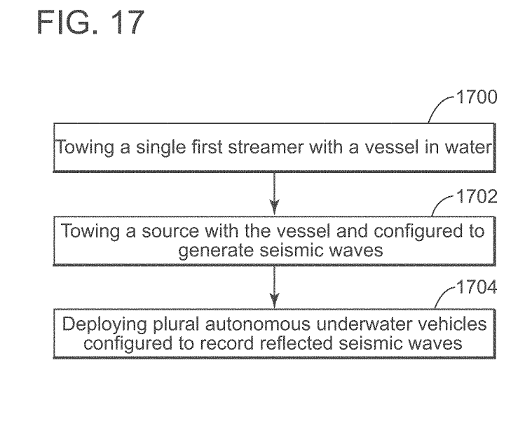

A method for collecting seismic data with one of the mixed-spread systems discussed above is now discussed with regard to FIG. 17. FIG. 17 is a flowchart of a method that includes a step 1700 of towing a single first streamer (106) with a vessel (102) in water, a step 1702 of towing a source (104) with the vessel (102) and configured to generate seismic waves, and a step 1704 of deploying plural autonomous underwater vehicles (AUVs) (122-i) configured to record reflected seismic waves. The plural AUVs (122-i) may be located along a straight line (124) that is substantially parallel to a traveling path (X) of the vessel (102). However, other configurations of the AUVs may be used. The single first streamer (106) includes plural seismic receivers (107) configured to also record the reflected seismic waves.

The method may further include a step of deploying additional AUVs along plural lines substantially parallel to the traveling path of the vessel. In one application, the plural lines are offset to each other along (1) the traveling path and (2) along a cross-line direction, which is perpendicular to the traveling path.

In one application, a set of AUVs inside a perturbation region (125) that extends over a couple of the plural lines, are programmed to move toward the source to increase a spatial density of AUVs inside the perturbation region relative to a zone outside the perturbation region. In another application, the plural AUVs are located along the straight line in front and behind the source, along the traveling path of the vessel.

The method may optionally include a step of towing a second single streamer (206′) with another vessel, the second single streamer extending parallel to the first single streamer (206). The plural AUVs are sandwiched between the first and second single streamers.

Various characteristics of the systems presented above are now discussed. The AUVs reside within the water column. The AUVs may be in communication with each other and/or a central communication unit located on the mother vessel or source vessel to coordinate positioning and/or transfer of data. The AUV may be one or more of the following: ROV (Remotely operated vehicle), AOV (Autonomously operated vehicle), submarine, surface buoy, or wave-glider.

Each AUV includes at least a seismic receiver. The receivers may include one or more of the following sensor types: hydrophones, accelerometers, differential hydrophones, particle velocity sensors, and/or particle motion sensors. Several receivers may be mounted on one AUV and may be used independently or in combination, for example, to estimate directional particle motion.

The AUVs have their own propulsion, which may or may not contaminate seismic data recordings with noise when operational. However, the AUVs may also drift with the current, which may be in the order of 0 to 1 m/s in low current environments or higher. Currents may vary, for example, with season or close to river systems. There may be limited or no control of the AUVs positions during recording. AUVs depths may be constant or may vary with time. In addition, the AUVs may all be at the same depth or may be at a range of depths, for example, to simulate a curved streamer, which is known in the art as Broadseis configuration.

The receivers associated with the AUVs may record signals originating from any type of seismic source. A seismic source towed by the vessel may include one or more of the following elements: airguns, marine vibrators, mini-sosie, vapourchoc, waterchoc, sparker, clapper, boomer, and weight drop.

A mixture of different source types may be used. In the case that a source consists of a number of source elements, the elements may be activated synchronously or in a de-synchronised way. This may generate either impulsive or non-impulsive signals. A mixture of impulsive and non-impulsive signals may be mixed. Non-impulsive signals may be of interest in areas sensitive to marine mammals, for example, during breading seasons. The source or sources may be operated within the Earth response time (the time for all recorded subsurface reflection of interest to be detected), which may give rise to an interference of energy between different sources. This may be due to more than one source operating within the same survey (e.g., cross-talk noise) or in more than one survey (e.g., interference noise).

Coverage of receivers may be important for processing, and for this reason spatially consistent bins (for example shot, receiver, acp, ccp, cmp, etc) bins may be defined. The coverage of a receiver bin may relate to shots fired once a receiver was positioned within the bin. The receiver bin may have a spatial extent within which the Earth response may be considered to be constant. The size of the bin will depend on the geological complexity, velocity of sound in the subsurface, and the target of interest. The dimensions of the bin may range from 6.25×6.25 m² to 50×50 m². Data relating to shots firing while the receiver is in the bin may be collected and processed as a group of traces known as a spatially consistent receiver gather. The data may be processed in a number of ways, for example, denoising, which may be random or coherent, including: cross-talk, interference noise, propulsion noise, random noise, multiples, swell noise, wavefield separation, e.g., separating up-going from down-going energy (either on source or receiver side), airgun bubble attenuation, or Δttenuation of non-isotropic source signature effects.

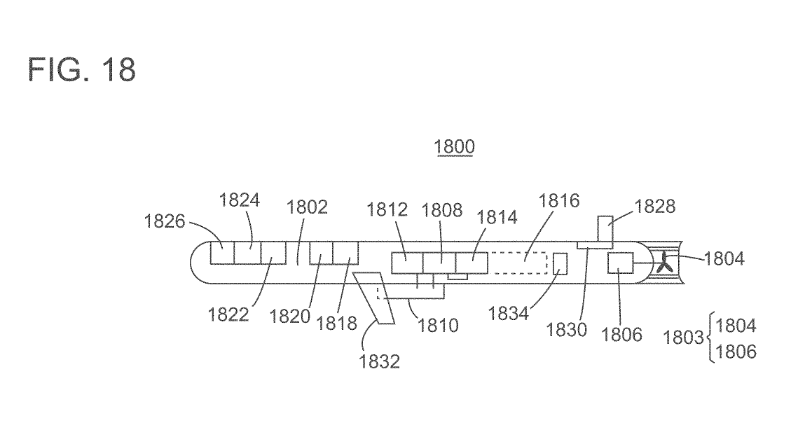

An AUV 1800 is now discussed with regard to FIG. 18, which illustrates an AUV having a body 1802 in which a propulsion system 1803 may be located. The propulsion system 1803 may include, for example, one or more propellers 1804 and a motor 1806 for activating the propeller 1804. Alternatively or in addition, the propulsion system may include adjustable wings for controlling a trajectory of the AUV. The motor 1806 may be controlled by a processor 1808. The processor 1808 may also be connected to a seismic sensor 1810. The seismic sensor 1810 may have a shape such that when the AUV lands on the seabed, the seismic sensor achieves a good coupling with the seabed sediment. The seismic sensor may include one or more of a hydrophone, geophone, accelerometer, etc. For example, if a 4C (four component) survey is desired, the seismic sensor 1810 includes three accelerometers and a hydrophone, i.e., a total of four sensors. Alternatively, the seismic sensor may include three geophones and a hydrophone. Of course, other sensor combinations are possible.

A memory unit 1812 may be connected to the processor 1808 and/or the seismic sensor 1810 for storing seismic data recorded by the seismic sensor 1810. A battery 1814 may be used to power all these components. The battery 1814 may be allowed to shift its position along a track 1816 to change the AUV's center of gravity.

The AUV may also include an inertial navigation system (INS) 1818 configured to guide the AUV to a desired location. An inertial navigation system includes at least a module containing accelerometers, gyroscopes or other motion-sensing devices. The INS is initially provided with the current position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation or velocity once it has been initialized. Further, using an INS is inexpensive.

Besides or instead of the INS 1818, the AUV may include a compass 1820 and other sensors 1822 as, for example, an altimeter for measuring its altitude, a pressure gauge, an interrogator module, etc. The AUV 1800 may optionally include an obstacle avoidance system 1824 and a communication device 1826 (e.g., Wi-Fi or other wireless communication) or other data transfer device capable of wirelessly transferring seismic data. In one embodiment, the transfer of seismic data takes place while the AUV is on the vessel. Also, it is possible that the communication device 1826 is a port wire-connected to the vessel to transfer the seismic data. One or more of these elements may be linked to the processor 1808. The AUV further includes an antenna 1828 (which may be flush with the AUV's body) and a corresponding acoustic system 1830 for communicating with the deploying, recovery or shooting vessel or other vehicle. Stabilizing fins and/or wings 1832 for guiding the AUV to the desired position may be used with the propulsion system 1803 for steering the AUV. However, in one embodiment, the AUV has no fins or wings. The AUV may include a buoyancy system 1834 for controlling the AUV's depth as will be discussed later.

The acoustic system 1830, which may be also present on the mother vessel for determining the AUV's position, may be an Ultra-Short Baseline (USBL) system, also sometimes known as Super Short Base Line (SSBL), which uses a method of underwater acoustic positioning. A complete USBL system includes a transceiver mounted on a pole under the mother vessel, and a transponder/responder on the AUV. It also may include a depth sensor (not shown) and/or a heading sensor (not shown) for reducing the ambiguity generated by the acoustic system 1830. A processor is used to calculate the AUV's position from the ranges and bearings the transceiver measures and also the depth or/and heading information. The processor may be located on the AUV or the mother vessel. For example, the transceiver transmits an acoustic pulse that is detected by the subsea transponder, which replies with its own acoustic pulse. This return pulse is detected by the transceiver on the vessel. The time from transmission of the initial acoustic pulse until the reply is detected is measured by the USBL system and converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less. The AUV 1800 illustrated in FIG. 18 is exemplary. Other AUVs may be used.

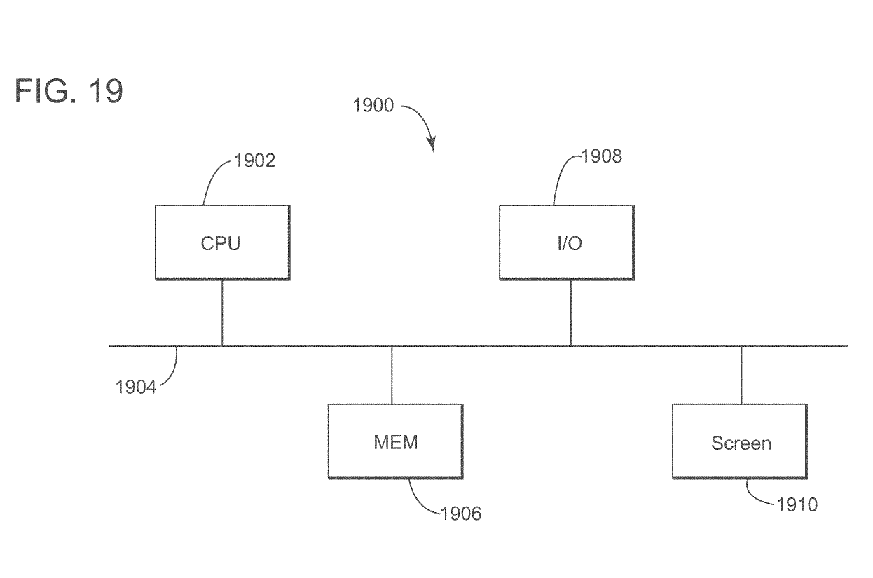

A computing device that may implement one or more of the methods discussed above are now discussed with regard to FIG. 19. Computing device 1900 includes a processor 1902 that is connected through a bus 1904 to a storage device 1906. Computing device 1900 may also include an input/output interface 1908 through which data can be exchanged with the processor and/or storage device. For example, a keyboard, mouse or other device may be connected to the input/output interface 1908 to send commands to the processor and/or to collect data stored in storage device or to provide data necessary to the processor. Also, the processor may be used to process, for example, seismic data collected during the seismic survey. Results of this or another algorithm may be visualized on a screen 1910, which may not be part of device 1900.

One or more of the embodiments discussed above disclose using a mixed-spread systems that includes a single streamer in combination with plural AUVs for performing seismic data acquisition. It should be understood that this description is not intended to limit the invention. On the contrary, the embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A marine mixed-spread seismic acquisition system comprising:
a single first streamer towed by a first vessel in water;
a source towed by the first vessel and configured to generate seismic waves; and
plural autonomous underwater vehicles (AUVs) configured to record reflected seismic waves,
wherein the single first streamer includes plural seismic receivers configured to also record the reflected seismic waves.

2. The system of claim 1, wherein the plural AUVs are located along a straight line that is substantially parallel to a traveling path of the first vessel.

3. The system of claim 2, further comprising:
additional AUVs distributed along plural lines substantially parallel to the traveling path of the vessel.

4. The system of claim 3, wherein a set of AUVs located inside a perturbation region that extends over the plural lines, are programmed to move toward the source to increase a spatial density of AUVs inside the perturbation region relative to a zone outside the perturbation region.

5. The system of claim 2, wherein a length L2 of the straight line is shorter than a length L1 of the first single streamer.

6. The system of claim 2, wherein a length L2 of the straight line is equal than a length L1 of the first single streamer.

7. The system of claim 2, wherein a length L2 of the straight line is longer than a length L1 of the first single streamer.

8. The system of claim 2, wherein the plural AUVs are located along the straight line behind the source, along the traveling path of the first vessel.

9. The system of claim 2, wherein the plural AUVs are located along the straight line in front and behind the source, along the traveling path of the first vessel.

10. The system of claim 1, further comprising:
a second single streamer that extends parallel to the first single streamer, and the second single streamer is towed by a second vessel,
wherein the plural AUVs are sandwiched between the first and second single streamers.

11. The system of claim 10, further comprising:
a waiting sector of AUVs located ahead of the first vessel along the traveling path; and
a recorded sector of AUVs located behind the single first streamer along the traveling path.

12. The system of claim 10, wherein the first vessel advances ahead of the second vessel along the traveling path.

13. The system of claim 10, wherein a distance between the first and second single streamers is larger smaller than a width of the array of AUVs.

14. The system of claim 1, wherein each AUV is assigned to an elliptical zone and the AUV is programmed to stay within the elliptical zone while recording the seismic data.

15. A method for collecting seismic data with a marine mixed-spread seismic acquisition system, the method comprising:
towing a single first streamer with a first vessel in water;
towing a source with the first vessel, wherein the source is configured to generate seismic waves; and
deploying in water plural autonomous underwater vehicles (AUVs) configured to record reflected seismic waves,
wherein the single first streamer includes plural seismic receivers configured to also record the reflected seismic waves.

16. The method of claim 15, further comprising:
wherein the plural AUVs are located along a straight line that is substantially parallel to a traveling path of the first vessel.

17. The method of claim 16, further comprising:
deploying additional AUVs along plural lines substantially parallel to the traveling path of the vessel.

18. The method of claim 17, wherein a set of AUVs inside a perturbation region that extends over the plural lines, are programmed to move toward the source to increase a spatial density of AUVs inside the perturbation region relative to a zone outside the perturbation region.

19. The method of claim 16, wherein the plural AUVs are located along the straight line in front and behind the source, along the traveling path of the vessel.

20. The method of claim 15, further comprising:
towing a second single streamer with a second vessel, the second single streamer extending parallel to the first single streamer,
wherein the plural AUVs are sandwiched between the first and second single streamers.
